(19) United States
(12) Patent Application Publication
(10) Pub. No.: US 2026/0329388 A1
(43) Pub. Date: Oct. 22, 2026

(54) PORTABLE CONTROLLER

(71) Applicant: LG ELECTRONICS INC., Seoul (KR)

(72) Inventors: Jungyun LEE, Seoul (KR); Eujin KIM, Seoul (KR); Kanghee MIN, Seoul (KR); Sungin CHOI, Seoul (KR); Hangseok KIM, Seoul (KR); Wonseok JOO, Seoul (KR)

(73) Assignee: LG ELECTRONICS INC., Seoul (KR)

(21) Appl. No.: 19/109,460

(22) PCT Filed: Dec. 29, 2022
(86) PCT No.: PCT/KR2022/021624

§ 371 Date: Mar. 6, 2025

(30) Foreign Application Priority Data
Sep. 22, 2022 (KR) 10-2022-0119899

(51) Int. Cl. G06F 3/02; G06F 3/01; G06F 3/0338; G06F 3/0354

(52) U.S. Cl. CPC G06F 3/0202; G06F 3/017; G06F 3/0338; G06F 3/03549

(57) ABSTRACT

A portable controller comprises: a basic controller including a handle part; and an extension module attachable to or detachable from the basic controller, wherein the basic controller includes: the handle part which extends in a lengthwise direction and is gripped by a user's hand; an operation body positioned in front of the handle part; a user input part positioned at the operation body; a first connector formed at the operation body; and a first coupling rail formed at the operation body, and the expansion module includes: a module body including a coupling part in contact with the operation body; a second connector formed at the coupling part and fastened to the first connector; and a second coupling rail slidably fastened in the lengthwise direction of the first coupling rail. The portable controller allows the expansion module to be easily attached thereto or detached therefrom to be able to expand and change the function thereof.

### TECHNICAL FIELD

The present disclosure relates to a controller for controlling an extended reality (XR) device.

### BACKGROUND ART

Virtual reality (VR) technology provides only computer graphic (CG) images of objects or backgrounds in the real world, augmented reality (AR) technology provides computer graphic images created virtually on real object images, and mixed reality (MR) technology is a computer graphic technology that provides virtual objects mixed and combined with the real world. The aforementioned VR, AR, and MR are collectively referred to as extended reality (XR) technology.

XR technology includes a device that provides images in the form of graphics, and a typical example is a device that is worn directly on the head, such as a head-mounted display (HMD).

The head-mounted display, which is worn on the head, allows users to use a portable handheld controller to input commands. While wired types are also available, recently, wireless portable controllers that send and receive data wirelessly have become more popular.

The portable controller goes beyond simply providing user input and provides feedback to the user through vibration. In addition, the portable controller may perform user input through gestures by detecting the movement of the user's hands (or arms) other than when the user directly manipulates buttons or wheels.

In addition, different gestures and feedback are performed depending on the content used, and the method of recognizing gestures varies depending on the type of XR device, whereby there is a problem of having to use different controllers depending on the situation.

### DISCLOSURE

### Technical Task

Therefore, it is an object of the present disclosure to provide a portable controller that can easily expand and change functions.

### Technical Solutions

The present disclosure provides a portable controller including a basic controller including a handle portion and an extension module detachably attached to the basic controller, wherein the basic controller includes the handle portion extending in a longitudinal direction, the handle portion being gripped by a user's hand, a manipulation body located in front of the handle portion, a first user input portion located on the manipulation body, a first connector formed on the manipulation body, and a first coupling rail formed on the manipulation body, and the extension module includes a module body including a coupling portion in contact with the manipulation body, a second connector formed on the coupling portion, the second connector being fastened to the first connector, and a second coupling rail slidably fastened in a longitudinal direction of the first coupling rail.

The first connector may be located in front of the manipulation body, the first coupling rail may be located in each of left and right directions of the manipulation body, and the coupling portion of the extension module may have a U-shape that wraps around the front and left and right sides of the manipulation body.

The second connector may protrude and may be inserted into the first connector.

The first coupling rail may include a groove having a wide front and gradually narrowing toward the rear, and the second coupling rail may have a bar shape with a thin rear and a thick front.

The extension module may include a locking hook formed at the coupling portion, and the basic controller may include a locking protrusion to which the locking hook is coupled.

The locking hook may be formed at one end of a hook lever rotatably coupled to the module body, an unlock button may be coupled to the other side of the hook lever, and when the unlocking button is manipulated, the hook lever may rotate and the locking hook may be separated from the locking protrusion.

The locking protrusion may include an inclined surface extending from the front to the rear and a catching portion bent from the inclined surface, the catching portion being configured to allow the hook to be caught thereby.

The locking hook may include a hook surface in contact with the catching portion, and an extension line from the center of rotation of the hook lever to the hook surface may be perpendicular to the hook surface.

The basic controller may include a locking hole, and the locking protrusion may be located on one side of the locking hole.

The locking protrusion may be located under the second connector.

An upper surface of the manipulation body and an upper surface of the module body may be parallel to each other.

The portable controller may further include a second user input portion located on an upper surface of the module body, wherein the first user input portion and the second user input portion may be located within a range of movement of a user's thumb.

The basic controller may be bilaterally symmetrical.

The extension module may include a ring case connected to both sides of the module body and a plurality of infrared LEDs (IR LEDs) mounted along an outer surface of the ring case.

The ring case may be located under the module body, and the outer surface of the ring case may be inclined toward the front.

The angle between the upper surface of the manipulation body and a front surface of the ring case may be inclined in a direction toward a rear surface by more than 90°.

### Advantageous Effects

According to at least one embodiment of the present disclosure, an extension module may be easily detachably attached to a portable controller to expand and change functions.

The effects obtainable from the present disclosure are not limited by the above mentioned effects, and other unmentioned effects can be clearly understood from the above description by those having ordinary skill in the technical field to which the present disclosure pertains.

### DESCRIPTION OF VIEWS

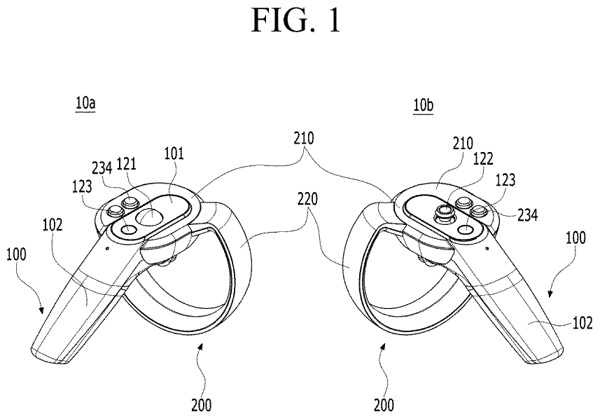

FIG. 1 is a perspective view showing a portable controller according to an aspect of the present disclosure.

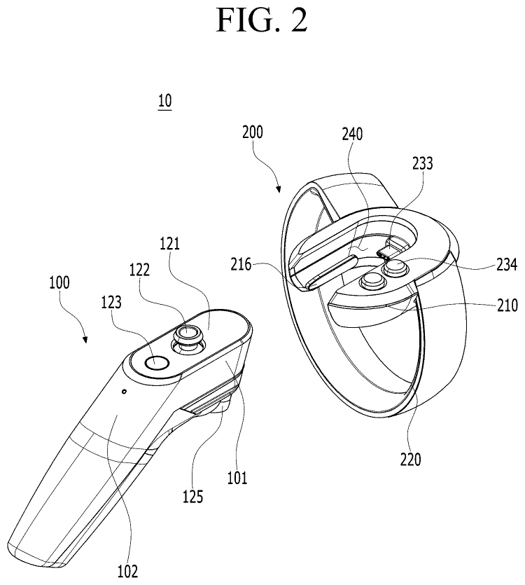

FIG. 2 is a view showing a basic controller and an extension module of the portable controller according to the aspect of the present disclosure.

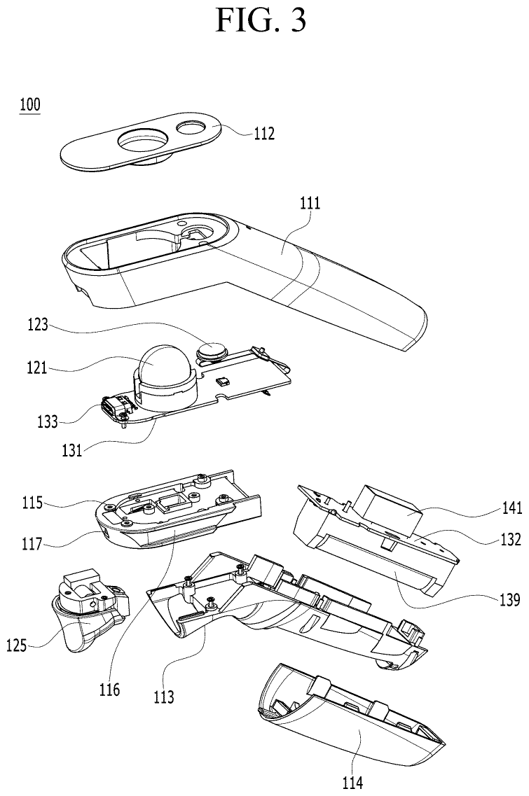

FIG. 3 is an exploded perspective view showing the basic controller of the portable controller according to the aspect of the present disclosure.

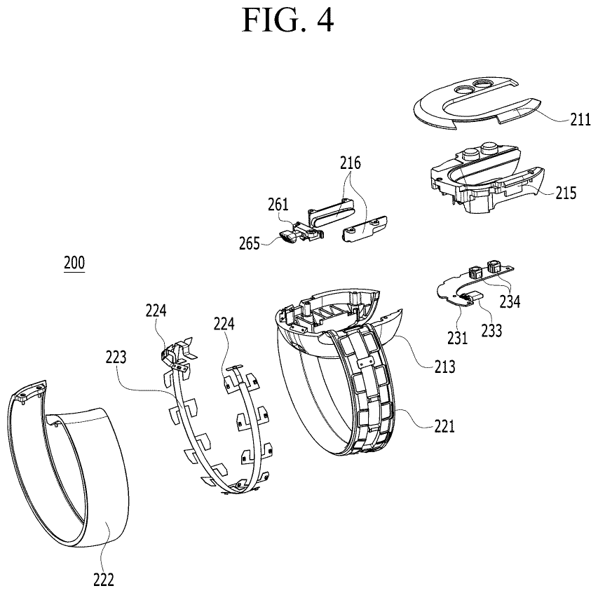

FIG. 4 is an exploded perspective view of the extension module of the portable controller according to the aspect of the present disclosure.

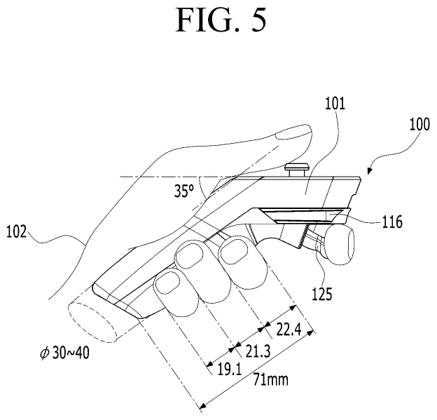

FIG. 5 is a side view showing a manipulation body of the portable controller according to the aspect of the present disclosure.

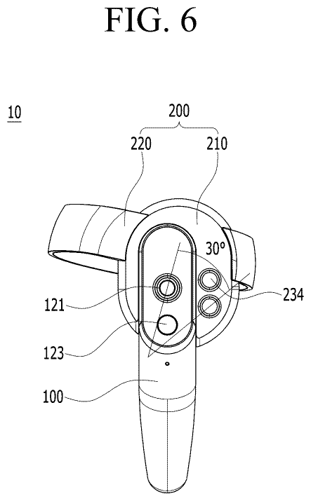

FIG. 6 is a plan view showing the manipulation body and a module body of the portable controller according to the aspect of the present disclosure.

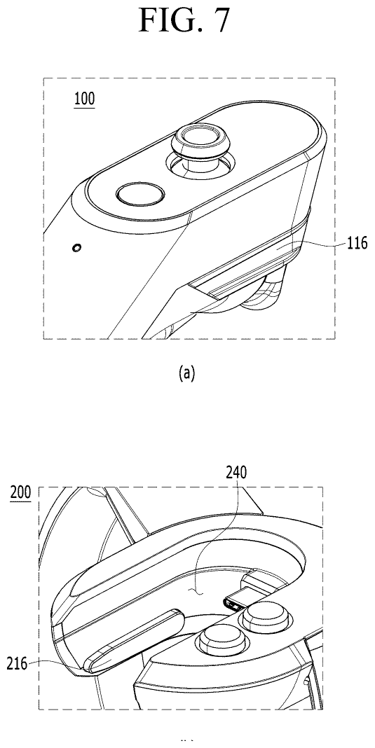

FIG. 7 is a view showing a connection portion and a locking portion of the portable controller according to the aspect of the present disclosure.

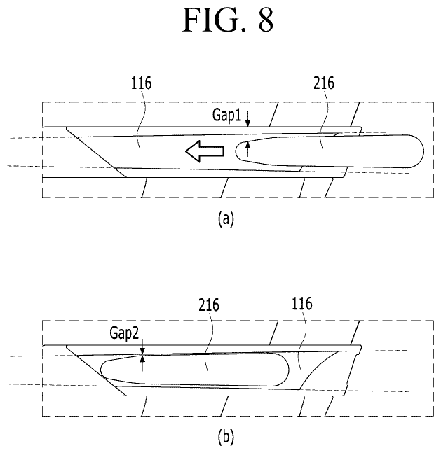

FIG. 8 is a view showing a coupling rail of the portable controller according to the aspect of the present disclosure.

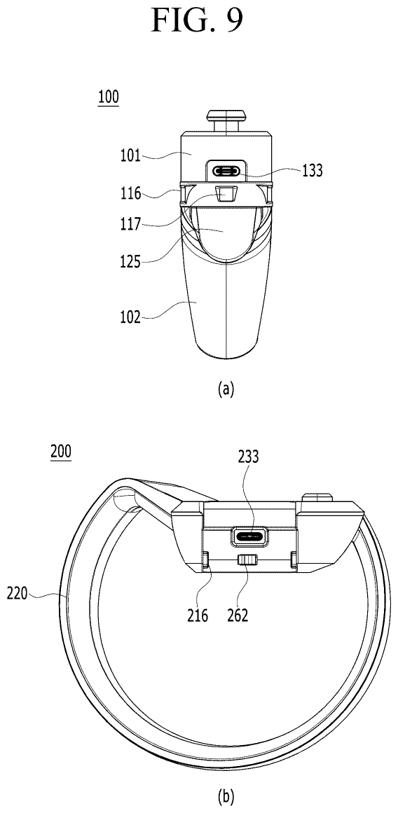

FIG. 9 is a view showing a fastening method of the coupling rail of the portable controller according to the aspect of the present disclosure.

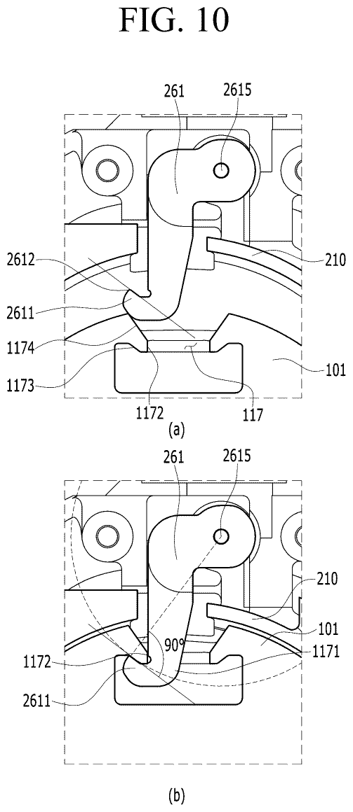

FIG. 10 is a view showing a locking method of the basic controller and the extension module of the portable controller according to the aspect of the present disclosure.

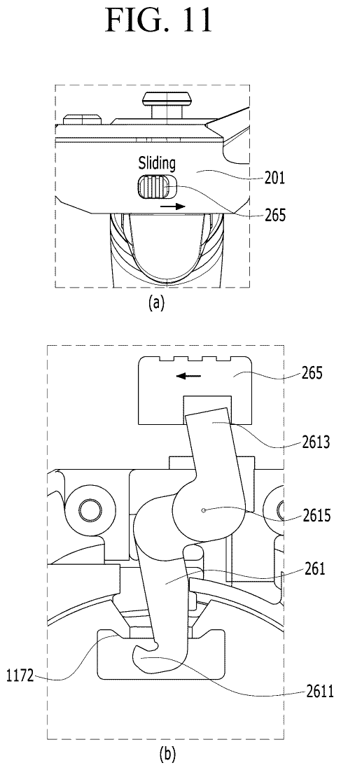

FIG. 11 is a view showing an unlocking method of the basic controller and the extension module of the portable controller according to the aspect of the present disclosure.

### BEST MODE FOR DISCLOSURE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

FIG. 1 is a perspective view showing a portable controller 10 according to an aspect of the present disclosure, and FIG. 2 is a view showing a basic controller and an extension module of the portable controller according to the aspect of the present disclosure.

XR technology may include an XR device that provides images in the form of graphics. The XR device may use a screen that is located in front of or around a user, and a device that is worn directly on the head, such as a head-mounted display (HMD), may be used as a representative XR device.

The XR device requires a portable controller 10 that users hold in their hand to input commands in order to immersively use the device while moving around.

The controller 10 of the present disclosure may include a handle portion 102 that is grasped by hand and a manipulation body 101 located in front of the handle portion 102. The handle portion 102 may be grasped by the palm at the bottom of the thumb, the middle finger, the ring finger, and the little finger, and buttons located on the manipulation body 101 may be manipulated using the index finger and the thumb.

The thumb may be used to manipulate a function key 123 and a trackball 121 or a joystick 122 located at an upper part of the manipulation body 101, and the index finger may be used to manipulate a trigger button 125 located at the front of the manipulation body 101.

A pair of controllers 10a and 10b may be configured as a set such that the user can hold and use the same in their left and right hands, respectively. The pair of controllers 10a and 10b may have the same buttons, but may be configured to allow various manipulations through different buttons.

For example, according to the embodiment shown in FIG. 1, the left side may include an input portion 121, 122, 123, and 125 in the form of a joystick 122, and the right side may include an input portion in the form of a trackball 121. The joystick 122 is advantageous for two-dimensional movement, and the trackball 121 may be used for rotation and gaze movement.

The number of portable controllers 10 required may vary depending on the application in use. In the case of an application with simple manipulation, only one basic controller 100 may be required to control the same, but in the case of applications requiring a variety of controls, it may be necessary to hold controllers in both hands.

When using an application that moves the gaze and explores the space, both the joystick 122 and the trackball 121 are required, whereby the portable controller 10a and 10b must be held in both hands. Either one or both of the controllers 10a and 10b may be used as needed.

The portable controller 10 may detect the user's gestures and recognize the same as user input, going beyond simply manipulating a cursor or a pointer on the screen.

The user's gestures may vary depending on the application that is used. For example, when using a sports application, user's movements may be detected through the portable controller 10. The functions required of the portable controller 10 may vary depending on how the XR device detects the user's gestures and the position of sensors of the XR device.

Conventionally, the user's gesture is detected based on the change in the position of the portable controller 10 using a position sensor, such as a gyro sensor, of the portable controller 10.

However, in the case of XR applications, it is necessary to detect more sophisticated user movements. In order to detect not only large gestures such as arm movements, but also small gestures such as bending the wrist and rotating the wrist, a method of externally tracking the movement of the controller may be used.

In addition, the portable controller 10 may function as an output that provides the user with tactile feedback, which is more than just sight and hearing, in addition to receiving user commands.

Tactile feedback provides a different sense depending on the direction, speed, and magnitude of vibration, in addition to vibration that oscillates in one direction. An actuator 141 that provides rich tactile feedback requires a plurality of actuators to provide various sensations.

However, in order to have the various input and output functions described above, the size of the portable controller 10 increases.

Accordingly, the portable controller 10 of the present disclosure may include a basic controller 100 and an extension module 200 detachably attached to the basic controller 100, as shown in FIG. 2.

Basic functions may be used with the basic controller 100 alone, but the extension module 200 with specialized functions for more precise control and to provide various sensations may be added to the basic controller 100.

The extension module 200 has a shape that can be inserted from the front of the basic controller 100, as shown in FIG. 2. The extension module may be coupled at the front of the manipulation body 101 so as not to interfere with the handle portion 102 extending in a direction toward the rear surface of the manipulation body 101.

In the coupled state shown in FIG. 1, functions installed in the extension module 200 may be additionally utilized. The extension module 200 of the present embodiment includes a ring case (an LED marker ring) 220, in which an LED marker 224 that can track the user's gestures is disposed.

The extension module 200 includes a module body 210 that includes a U-shaped coupling portion 240 that wraps around front and side surfaces of the manipulation body 101. The module body 210 may be equipped with a module for additional functions inside, for example, an additional button as shown in FIG. 3. The module body 210 may be deformed into various shapes according to the function of the extension module 200.

A coupling rail is provided to ensure that the basic controller 100 and the extension module 200 are stably fastened to each other, and a second connector 233 configured to electrically connect the extension module 200 and the basic controller 100 to utilize the functions of the extension module 200 may be provided. The connector and the coupling rail may be located on the side perimeter of the manipulation body 101 where the basic controller 100 and the extension module 200 are in contact with each other and at the coupling portion 240 of the extension module 200.

FIG. 3 is an exploded perspective view showing the basic controller 100 of the portable controller 10 according to the aspect of the present disclosure.

The basic controller 100 includes a case 111, 112, 113, 114, and 115 forming the external shape thereof, and the case may be configured separately from the handle portion 102 and the manipulation body 101, but the present embodiment may ensure the assembly of parts through the case 111 and 112 coupled in a vertical direction.

The manipulation body 101 includes a trigger button 125, function keys, and a trackball 121 mounted on a main board 131. The handle portion 102 may include a battery 139 and a basic actuator 141 that transmits vibration, and may be mounted on an auxiliary board 132 and connected to the main board 131 to detect user input.

The case 111, 112, 113, and 114 is made of an injection molded material for ease of manufacturing, but the middle frame 115 that is partially rigid may be equipped for durability. The middle frame 115 is located under the main board 131 of the manipulation body 101 and may support a rear surface of the input portion when the input portion is pressed. The trigger button 125 is also coupled to the middle frame 115, and the frame may support the force of the trigger button 125 by pressing the button in a direction toward the frame.

A top cover 112 with an opening may be coupled to an upper surface of the manipulation body 101 such that the user input portion is exposed. A lower part of the handle portion 102 may further include a bottom cover 114 made of a different material to improve the grip. The top cover 112 and the bottom cover 114 may be omitted.

The basic controller 100 may be configured to be symmetrical to the left and right so as to be used without distinction between the left and right hands. When using a pair of basic controllers 100, a basic controller 100 with a trackball 121 and a basic controller 100 with a joystick 122 may be used, and since they are symmetrical, the left and right sides may be arbitrarily set and changed by the user.

FIG. 4 is an exploded perspective view of the extension module 200 of the portable controller 10 according to the aspect of the present disclosure.

The module body 210 of the present embodiment may include a lower case 213, a middle frame 215, and an upper cover 211.

A ring case 221 and 222 extending from the left and right sides of the module body 210 is included, wherein the ring case 221 and 222 may be integrally formed with the module body 210 or may be fastened to the module body 210.

In the present embodiment, the lower case 213 of the module body 210 and the inner case 221 of the ring case may be integrally formed, and the outer cover 222 enclosing an outer surface of the ring case may be coupled to the inner case 221.

The LED lamp (the LED marker) 224 is mounted between the inner case 221 and the outer cover 222, and the LED lamp 224 may be provided in one pair on each of the left and right sides facing the outside of the ring case 221 and 222. The LED lamps 224 may be connected to each other via a flexible substrate 223. The outer cover 222 may include a light-transmissive material that allows infrared light to pass therethrough.

The XR device is provided with a sensor configured to detect the movement of the LED marker 224 mounted on the ring case 221 and 222, and the sensor may detect the user's gestures by tracking the movement of the LED marker 224.

The LED marker ring 220 shown in FIG. 1 may detect movement through a camera located in front, and if the LED marker 224 is tracked in the head-mounted display worn on the user's head, the placement of the LED marker 220 must be changed such that the LED marker 224 faces the user's face.

In the present embodiment, the LED marker 224 is disposed along the outer surface of the ring case 221 and 222, and therefore the outer surface of the ring case 221 and 222 may curved slightly forward such that the LED marker 224 located at the rear can also be recognized by the camera located at the front. That is, the hole size at the front of the ring case 221 and 222 may have a smaller hole size than the hole size at the rear.

The module body 210 may be further provided with an expansion button 234, and a module board 231 provided with the expansion button 234 may be mounted on the module body 210. The module board 231 is connected to the LED marker 224, and may further include a second connector 233 configured to transmit the functions installed in the extension module 200 to the basic controller 100. Through the second connector 233, a control unit of the basic controller 100 may control the LED marker 224 and receive input from the expansion button to control the XR controller.

FIG. 5 is a side view showing the manipulation body 101 of the portable controller 10 according to the aspect of the present disclosure. For a better grip, the handle portion 102 is configured as a cylindrical shape having a diameter of 30 to 40 mm, and may become thinner toward a lower end thereof.

Since the average adult finger size, which is the sum of the width of the middle finger, the ring finger, and the little finger, is about 62.8 mm, the length of the handle portion 102 may be configured to be 71 mm, taking this into account.

The angle of the handle portion 102 may be configured so as to be bent at an angle of about 35° to an upper surface of the manipulation body 101. The angle between the handle and the upper surface of the manipulation body 101 may be determined in consideration of the operability of the thumb.

The length of the manipulation body 101 in a forward-rearward direction may be determined in consideration of the position of the index finger appropriate to manipulate the trigger button 125 located at a lower part of the front of the manipulation body 101.

FIG. 6 is a plan view showing the manipulation body 101 and the module body 210 of the portable controller 10 according to the aspect of the present disclosure.

The user input portion 121, 122, 123, and 234 may be disposed in consideration of the range of movement of the thumb (30°) such that the user can control not only the function key 123 and the joystick 122 (trackball 121) located on the upper surface of the manipulation body 101 but also the expansion button 234 located at the extension module 200 by the thumb.

FIG. 7 is a view showing the coupling rail of the portable controller 10 according to the aspect of the present disclosure, FIG. 6(a) shows a first coupling rail 116 of the basic controller 100, and FIG. 6(b) shows a second coupling rail 216 of the extension module 200. The first coupling rail 116 may have a concave shape, and the second coupling rail 216 may have a protruding shape.

Since the basic controller 100 should not cause any inconvenience when only the basic controller 100 is used, the basic controller includes a concave structure rather than a protruding structure, and in particular, the coupling portion 240 of the extension module 200 has a U-shape, whereby there is a low risk of damage to a protruding coupling structure.

The first coupling rail 116 may have a groove shape, and the second coupling rail 216 may have a bar shape. The groove of the first coupling rail 116 may become narrower toward the rear, and the second coupling rail 216 may also have a shape in which the rear is thinner than the front. The second coupling rail 216 may be configured to have a curved surface at the rear to facilitate coupling with the first coupling rail 116.

FIG. 8 shows a fastening method of the coupling rail of the portable controller 10 according to the aspect of the present disclosure. The left side is the rear, the right side is the front, and only the second coupling rail 216 of the extension module 200 based on the basic controller 100 is shown.

The rear of the second coupling rail 216 is inserted into the front of the first coupling rail 116, and initially there is a large gap (gap1, (a)) between the first coupling rail 116 and the second coupling rail 216. When the coupling is completed, the gap between the first coupling rail 116 and the second coupling rail 216 disappears (gap2=0), and the extension module 200 may be fully coupled to the basic controller 100.

FIG. 9 is a view showing a connector 133 and 233 and a locking portion 260 of the portable controller 10 according to the aspect of the present disclosure. (a) is a front view of the basic controller 100, and (b) is a rear view of the extension module 200.

The first connector 133 and a locking hole 117 are located at a front surface of the basic controller 100, and the first coupling rail 116 is located on each of the left and right sides. The second coupling rail 216 is located on each of the left and right sides of the coupling portion 240 of the extension module 200, and the second connector 233 and a locking hook 2611 protrude from the U-shaped inner end.

Like the second coupling rail 216, each of the connector (second connector 233) and locking structure (locking hook 2611) of the extension module 200 has a protruding shape, and each of the connector (first connector 133) of the basic controller 100 and the locking structure (locking protrusion 1172 located in the locking hole 117) may have a form that does not protrude but is inwardly recessed.

As shown in FIG. 3, the protruding second connector 233 of the extension module is inserted into the first connector 133 of the basic controller 100, and the extension module 200 and the basic controller 100 may be electrically connected to each other.

Coupling is completed when the front surface of the basic controller 100 and the inner surface of the coupling portion 240 of the extension module 200 come into contact with each other. The coupling rail assists in coupling between the extension module 200 and the basic controller 100, but the portable controller 10 moves while being held by the user, and therefore a locking device configured to ensure stable coupling may be provided.

The locking device of the present disclosure may include a locking hook 2611 protruding from the extension module 200 and a locking protrusion 1172 of the basic controller 100.

FIG. 10 is a view showing a locking method of the basic controller 100 and the extension module 200 of the portable controller 10 according to the aspect of the present disclosure. The locking hook 2611 of the present disclosure is formed on one side of a hook lever 261 rotatably coupled to the module body 210 and protrudes from the module body 210.

When the basic controller 100 is inserted into the coupling portion 240 of the extension module 200 along the coupling rail 116 and 216, the end of the locking hook 2611 comes into contact with an inclined surface 1174 formed in front of a coupling protrusion of the basic controller. As the locking hook 2611 moves along the inclined surface 1174 of the coupling protrusion, the horizontal position changes (moving in a right direction in the figure), whereby the hook lever 261 rotates, changing the horizontal position of the locking hook 2611.

When the locking hook 2611 reaches the end of the inclined surface 1174, the locking hook 2611 is fitted onto the locking protrusion 1172 as shown in FIG. 9(b), whereby the basic controller 100 and the extension module 200 may be fastened to each other.

The locking protrusion 1172 may include a catching portion 1173 that is bent from the inclined surface 1174 and is located on the opposite side of the inclined surface 1174, and the locking hook 2611 may include a hook surface 2612 configured to be in contact with the catching portion 1173.

The hook surface 2612 may be perpendicular to an extension line from a rotation axis 2615 of the hook lever 261 to the hook surface 2612 to prevent the locking hook 2611 from being separated from the locking protrusion 1172.

The locking protrusion 1172 may be formed on the side of the locking hole 117 formed in front of the basic controller 100, and the locking protrusions 1172 may be formed on each of the left and right sides of the locking hole 117. The basic controller 100 may be used without distinction between left and right, and therefore both a left-facing extension module 200 and a right-facing extension module 200 of the extension module may be coupled to the basic controller.

FIG. 11 is a view showing an unlocking method of the basic controller 100 and the extension module 200 of the portable controller 10 according to the aspect of the present disclosure. The other side 2613 of the hook lever 261 is connected to an unlock button 265.

The unlock button 265 operates in a sliding manner, and the hook lever 261 rotates around the rotation axis 2615 and the position of the locking hook 2611 located on one side of the hook lever 261 may change depending on the sliding direction.

The unlock button 265 is located in front of the extension module 200, and the hook lever 261 is disposed in the frontward-rearward direction of the module body 210 of the extension module 200. When the user slides the unlock button 265 of FIG. 11 (a) in a locked state as shown in FIG. 10 (b), the hook lever 261 rotates as shown in FIG. 11 (b), and the locking hook 2611 may be released from the locking protrusion 1172.

As is apparent from the above description, at least one embodiment of the present disclosure allows expansion and modification of functions by easily detachably attaching the extension module to the portable controller 10.

The above detailed description should not be construed as being limitative in all terms, but should be considered as being illustrative. The scope of the present disclosure should be determined by reasonable analysis of the accompanying claims, and all changes in the equivalent range of the present disclosure are included in the scope of the present disclosure.

What is claimed is:

1. A portable controller comprising:
a basic controller comprising a handle portion; and
an extension module detachably attached to the basic controller, wherein the basic controller comprises:
the handle portion extending in a longitudinal direction, the handle portion being gripped by a user's hand;
a manipulation body located in front of the handle portion;
a first user input portion located on the manipulation body;
a first connector formed on the manipulation body; and
a first coupling rail formed on the manipulation body, and
the extension module comprises:
a module body comprising a coupling portion in contact with the manipulation body;
a second connector formed on the coupling portion, the second connector being fastened to the first connector; and
a second coupling rail slidably fastened in a longitudinal direction of the first coupling rail.

2. The portable controller of claim 1, wherein
the first connector is located in front of the manipulation body,
the first coupling rail is located in each of left and right directions of the manipulation body, and
the coupling portion of the extension module has a U-shape that wraps around the front and left and right sides of the manipulation body.

3. The portable controller of claim 2, wherein the second connector protrudes and is inserted into the first connector.

4. The portable controller of claim 1, wherein the first coupling rail comprises a groove having a wide front and gradually narrowing toward a rear, and
the second coupling rail has a bar shape with a thin rear and a thick front.

5. The portable controller of claim 1, wherein
the extension module comprises a locking hook formed at the coupling portion, and
the basic controller comprises a locking protrusion to which the locking hook is coupled.

6. The portable controller of claim 5, wherein
the locking hook is formed at one end of a hook lever rotatably coupled to the module body,
an unlock button is coupled to the other side of the hook lever, and
when the unlocking button is manipulated, the hook lever rotates and the locking hook is separated from the locking protrusion.

7. The portable controller of claim 6, wherein the locking protrusion comprises:
an inclined surface extending from a front to a rear; and
a catching portion bent from the inclined surface, the catching portion being configured to allow the hook to be caught thereby.

8. The portable controller of claim 7, wherein
the locking hook comprises a hook surface in contact with the catching portion, and
an extension line from a center of rotation of the hook lever to the hook surface is perpendicular to the hook surface.

9. The portable controller of claim 5, wherein
the basic controller comprises a locking hole, and
the locking protrusion is located on one side of the locking hole.

10. The portable controller of claim 5, wherein the locking protrusion is located under the second connector.

11. The portable controller of claim 1, wherein an upper surface of the manipulation body and an upper surface of the module body are parallel to each other.

12. The portable controller of claim 1, further comprising:
a second user input portion located on an upper surface of the module body, wherein
the first user input portion and the second user input portion are located within a range of movement of a user's thumb.

13. The portable controller of claim 1, wherein the basic controller is bilaterally symmetrical.

14. The portable controller of claim 1, wherein the extension module comprises:
a ring case connected to both sides of the module body; and
a plurality of infrared LEDs (IR LEDs) mounted along an outer surface of the ring case.

15. The portable controller of claim 14, wherein
the ring case is located under the module body, and
the outer surface of the ring case is inclined toward a front.

16. The portable controller of claim 14, wherein an angle between an upper surface of the manipulation body and a front surface of the ring case is inclined in a direction toward a rear surface by more than 90°.
